(19) United States
(12) Patent Application Publication
(10) Pub. No.: US 2002/0168246 A1
(43) Pub. Date: Nov. 14, 2002

(54) Threadless bolt and nut combination

(76) Inventor: Sergey Dmitrievich Voznesensky, St. Petersburg (RU)

Correspondence Address: Mr. Walter J. Tencza Jr., Suite 3, 10 Station Place, Metuchen, NJ, 08840, US

(21) Appl. No.: 09/855,172

(22) Filed: May 14, 2001

(51) Int. Cl. F16B 21/18

(52) U.S. Cl. 411/530

(57) ABSTRACT

An apparatus is disclosed comprising a bolt having a shaft which includes a tapered section and a spiral insert which can be placed over the tapered section of the shaft and thereby fixed to the bolt. The spiral insert may be a spring. The bolt may include a bolt head and may have a uniform section which has a uniform diameter. The apparatus may further include a nut which has a tapered inner chamber such that the nut can be placed over the spiral insert to fix the nut to the spiral insert and to thereby fix the nut to the bolt. The tapered section may be conical in shape and may have a first diameter which tapers to a second diameter which is smaller than the first diameter. A method I also disclosed comprising the steps of creating a tapered section on an end of a bolt and pressing a spiral insert over the end and over the tapered section. The step of creating a tapered section on the end of the bolt may include pressing the bolt into a conical mold. The method may also include creating a tapered inner chamber in a nut by reaming a nut with a previously uniform inner chamber. The bolt may be two sided and may have a first tapered section and a second tapered section over which first and second spiral inserts may be provided. A first rod and a second rod may be placed over the first and second spiral inserts.

### FIELD OF THE INVENTION

This invention relates to improved methods and apparatus for making and using nuts and bolts.

### BACKGROUND OF THE INVENTION

Traditional bolts and nuts have threads. As a bolt is rotated axially and inserted into the hole of the nut, the threads on the surface of the bolt engage with the threads lining the hole of the nut. With each turn of the bolt, as it is inserted further into the nut, the tensile strength of the nut bolt combination increases. This tensile strength reaches its maximum once all of the threads of the nut are surrounded by the threads of the bolt.

Making threads on a nut or bolt is costly. A machine spins the bolt or nut and threads are cut into the surface with a die made of harder metal. These dies wear and must be replaced. Also, when threads are cut into a bolt, the working diameter of the bolt is reduced. The tensile strength is reduced by an amount equal to the percent reduction in the cross-sectional area of the bolt. The depth of the threads reduces the effective cross-sectional area of the bolt.

### SUMMARY OF THE INVENTION

The present invention in one or more embodiments includes a threadless bolt, a threadless nut and a spiral insert, such as a spring, that is press fit onto the bolt. The spiral insert should be made of a metal (or other material, such as plastic) that is harder than the metal (or other material, such as plastic) which the bolt and nut are made from. Preferably, this spiral insert is made of spring steel with high tensile strength and designed to handle dynamic loads. It can be manufactured easily by a machine that tightly winds steel wire into an endless coil which may have a single diameter. The manufacture of spring coil is a non-abrasive metal bending operation, and therefore does not consume nearly as much tooling or energy as to produce threads.

An important feature of one or more embodiments of the present invention is the varying diameter of the shaft of the bolt and the hole or inner chamber of the nut. In particular, the bolt face that engages the nut has a smooth surface and the bolt has a tapered section which is conical in shape, tapering toward the end to be inserted into the nut. The hole or inner chamber of the nut has a smooth surface and is also conically shaped, and should have substantially the same angle of conicity as the bolt. This angle of conicity can be varied for different designs of nut bolt combinations, depending on the hardness of the materials used and the number of turns of the nut necessary to attain full tensile strength of the nut bolt combination. Nut bolt designs for most applications will have a conicity angle ranging from 1:10 to 1:100 or less.

### BRIEF DESCRIPTION OF THE DRAWINGS

FIG. 1 shows a side view of a bolt for use in accordance with a first embodiment of the present invention;

FIG. 2 shows a view of the top or head of the bolt of FIG. 1;

FIG. 3 shows a view of the bottom of the bolt of FIG. 1;

FIG. 4 shows a side view of a spiral insert or spring for use in accordance with a first embodiment of the present invention;

FIG. 5 shows a view of the bottom of the spiral insert of FIG. 4;

FIG. 6 shows a view of the top of the spiral insert of FIG. 4;

FIG. 7 shows a side view of the spiral insert of FIG. 4 pressed onto the bolt of FIG. 1 in accordance with a first embodiment of the present invention;

FIG. 8 shows a front view of a nut for use with the bolt and spiral insert of FIGS. 1 and 4 in accordance with an embodiment of the present invention;

FIG. 9 shows a side view of the nut of FIG. 8;

FIG. 10 shows the nut of FIG. 8 placed on the combination of the spiral insert and the bolt shown in FIG. 7;

FIG. 11 shows a side view of a two sided bolt with two spiral inserts in accordance with a second embodiment of the present invention;

FIG. 12 shows a side view of two bars or rods having tapered inner chambers with dashed lines showing the tapering of the inner chambers;

FIG. 13 shows the two bars connected to the two side bolt of FIG. 11;

FIG. 14 shows a cross section of a bolt shaft, a nut and a spiral insert in accordance with another embodiment of the present invention where the spiral insert has a octagonal cross section; and

FIG. 15 shows a cross section of a bolt shaft, a nut and a spiral insert in accordance with another embodiment of the present invention where the spiral insert has a hexagonal cross section.

### DETAILED DESCRIPTION OF THE DRAWINGS

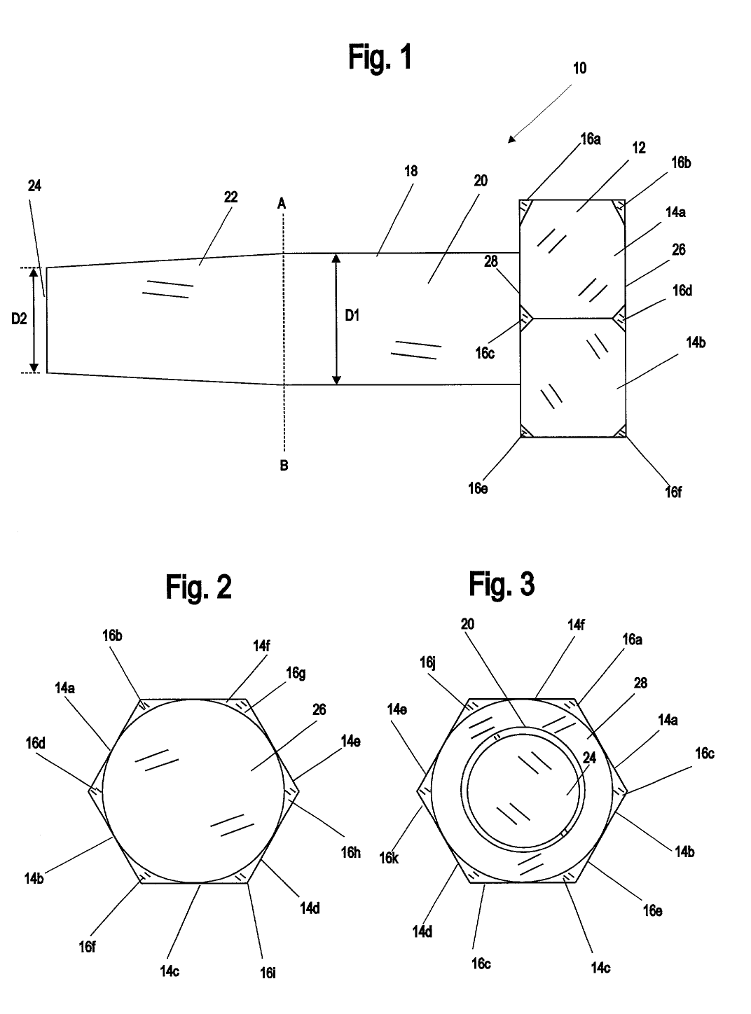

FIG. 1 shows a side view of a bolt 10 for use in accordance with a first embodiment of the present invention. FIG. 2 shows a view of the top of the bolt 10 of FIG. 1 and FIG. 3 shows a view of the bottom of the bolt 10 of FIG. 2. The bolt 10 includes a bolt head 12 and a bolt shaft 18.

Bolt head 12 includes surfaces 14a, 14b, 14c, 14d, 14e, and 14f as shown in FIG. 2. Surfaces 14a and 14b are shown in FIG. 1. Bolt head 12 also includes tapered portions 16a, 16b, 16c, 16d, 16e, and 16f shown in FIG. 1, tapered portions 16g, 16h, and 16i shown in FIG. 2, and tapered portions 16j, 16k, and 16l shown in FIG. 3. Bold head 12 also includes top surface 26 shown in FIG. 2, and bottom surface 28 shown by FIGS. 1 and 3.

Bolt shaft 18 is comprised of uniform section 20 and tapered section 22 shown in FIG. 1. Tapered section 22 has an end 24 which has a diameter of D2, which may range from under one-eighth of an inch to several inches. The end 24 may be a circular surface as shown in FIG. 3. The dashed line AB in FIG. 1 shows the division between tapered section 22 and section 20. The diameter of tapered section 22 decreases from a diameter of D1, which may range from under one-eighth of an inch to three or more inches at the dashed line AB to a diameter of D2 at the end 24. The tapered section 22 is solid. The section 20 is a solid cylinder which has a consistent diameter of D1. The tapered section 22 and the section 20 of the bolt shaft 18 may actually be one integrated piece but may be referred to as separate sections for description purposes. The bolt head 12 and the bolt shaft 18 may be made of any of a number of materials that elastically and plastically deform, such as steel, various metal alloys, plastic, wood, composite materials, etc.

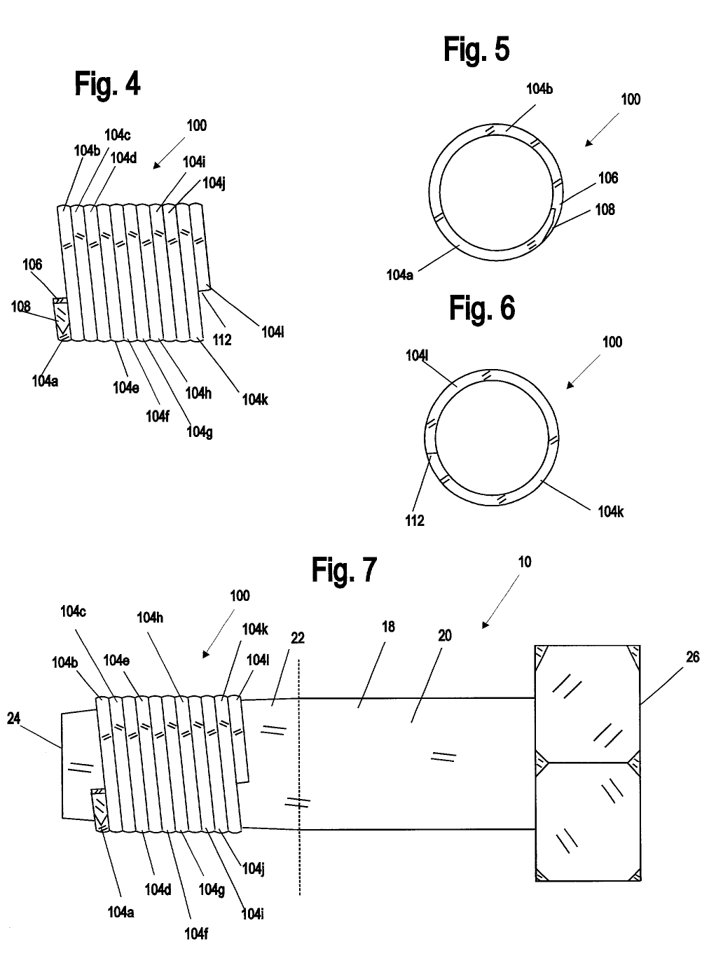

FIG. 4 shows a side view of a spiral insert 100 for use in accordance with a first embodiment of the present invention. FIG. 5 shows a view of the bottom of the spiral insert 100 of FIG. 4 and FIG. 6 shows a view of the top of the spring of FIG. 4. The spiral insert 100 may be a spring made of spring steel. The spiral insert may also be made of a number of materials that do not fracture under dynamic loads, such as metal alloys, polymers, plastics, composite materials, etc.

The spiral insert 100 includes windings 104a, 104b, 104c, 104d, 104e, 104f, 104g, 104h, 104i, 104k, and 1041. However, a greater or lesser number of windings can be provided. The windings 104b-104k are circular, while the windings 104a and 1041 are somewhat truncated circles in shape. The winding 104a shown in FIG. 4 and FIG. 5 ends in ending 106 and has a tapered portion 108. The tapered portion 108 is used to ensure that it does not catch on, or scratch, other surfaces, improved safety in handling, etc. The winding 1041 ends at ending 112 shown in FIG. 4 and FIG. 6.

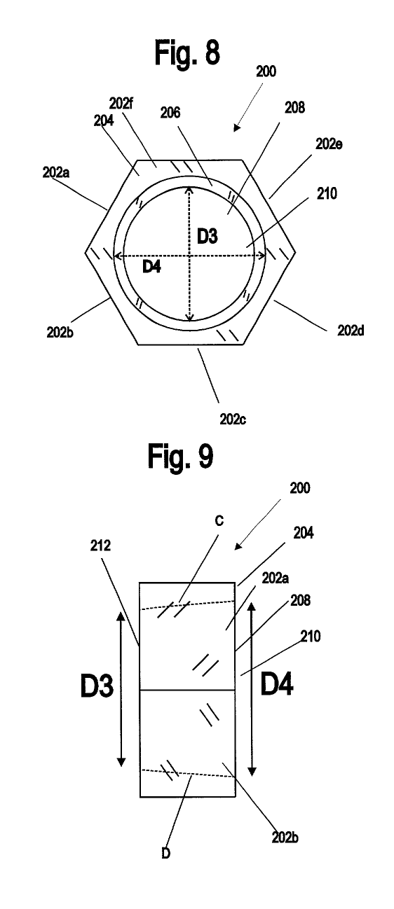

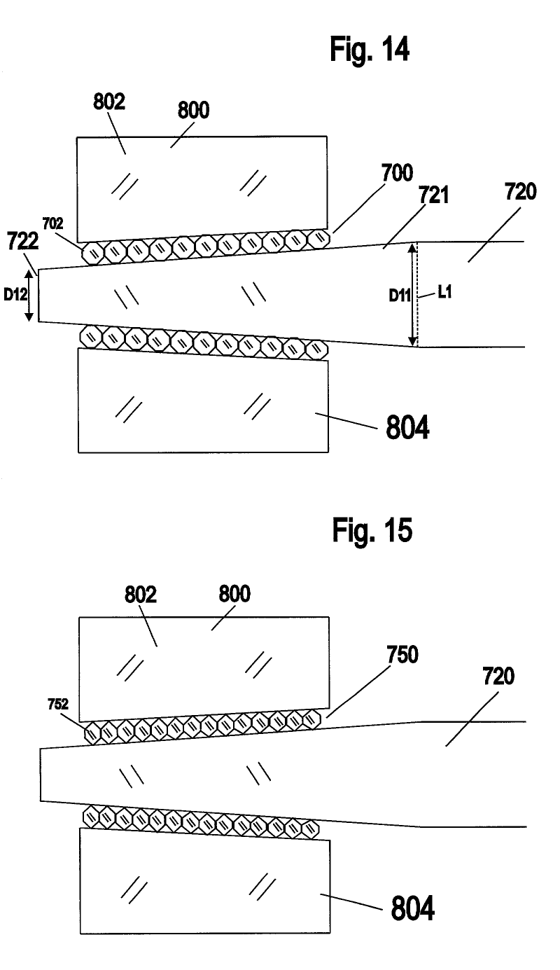

The cross-section of the spring steel wire which may be used to make the spiral insert 100 of the first embodiment may be round. During manufacture, this spring steel wire can be drawn through a round die to reduce its diameter. In another embodiment, the wire can be drawn through a die with a non-round shape prior to being wound as a coil. Its cross section may be hexagonal, octagonal, oval, etc. See for example FIGS. 14 and 15. Although these different cross sectional designs may increase manufacturing costs, they will provide the opportunity to increase the plastic deformation of the conical surfaces of a nut, such as nut 200 in FIG. 8, and the bolt 10 prior to the compressive destruction of the spiral insert 100, thereby increasing the maximum tensile load capacity of the nut bolt combination. These non-round cross-section designs also works well for other materials to be used for the insert described before.

In the first embodiment the spiral insert 100 is not intended to spin on the bolt 10, so that the spiral insert 100 and bolt 10 combination functions as one piece relative to the nut 200. In another embodiment, a bolt similar to 10 and a spiral insert similar to 100 are made as one piece. This one-piece design is especially useful when plastics, or molded materials, are used. The bolt and spiral insert can be injection molded less expensively as one piece. The outer surface of this one-piece bolt design would be the same as the bolt 10 with insert 100 installed as shown in FIG. 7. In addition, the conical face of the one-piece design bolt may have a similar surface texture as results from when the spiral insert wire cross section is either round or non-round as shown in FIG. 14 and FIG. 15. The molded material used for the bolt 10 with spiral insert 100 must be harder than that of the material used for the nut, such as nut 200. The same plastic and elastic deformation dynamics that occur between the one-piece bolt spiral insert and the conical face of the nut (such as nut 200) are contemplated to occur as described in the first embodiment for bolt 10 and spiral insert 100.

FIG. 7 shows a side view of the spiral insert 100 of FIG. 4 pressed onto the bolt 10 of FIG. 1 in accordance with a first embodiment of the present invention. The spiral insert 100 can be pressed onto bolt 10 during a manufacturing process so that the combination of the spiral insert 100 and the bolt 10 can be used for connecting to a nut 200 shown in FIG. 8.

FIG. 8 shows a front view of the nut 200 for connecting to the combination of the spiral insert 100 and the bolt 10 shown in FIG. 7. FIG. 9 shows a side view of the nut 200 along with dashed lines for showing a tapered inner diameter. The nut 200 includes surfaces 202a, 202b, 202c, 202d, 202e, and 202f. The nut 200 also includes surface 204 and inner tapered area 206. An inner chamber 208 is shown in the nut 200 in FIG. 8. The inner chamber 208 is bounded by the smooth conelike shape of the inner tapered area 206. The inner chamber 208 has an inner diameter of D4, which may range from under one-eighth of an inch to over three inches and more, at the end 210 which tapers to an inner diameter of D3, which ranges from under one-eight of an inch to over three inches and more, at the end 212 shown in FIGS. 8 and 9. D4 is larger than D3. The dashed lines C and D in FIG. 9 show the tapering of the inner chamber 208 through the nut 200.

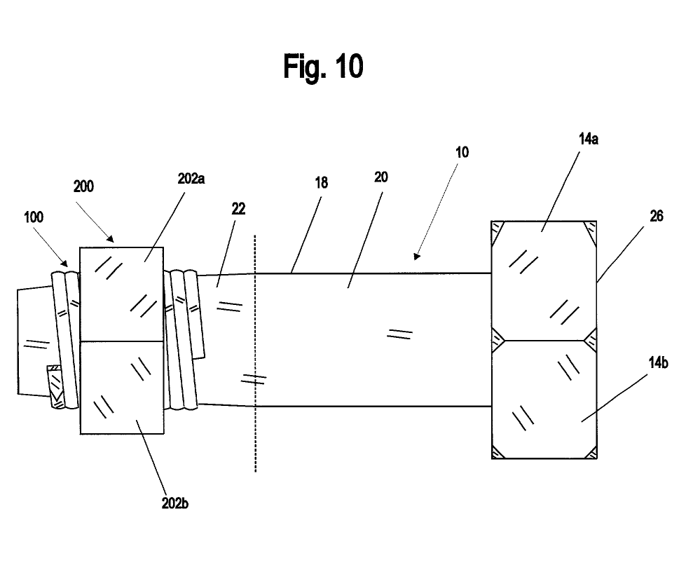

FIG. 10 shows the nut 200 placed on the combination of the spiral insert 100 and the bolt 10. The nut 200 can be screwed on to tighten. The nut 200 can be made of materials similar to those described for the bolt shaft 18 and its conical inner surface 206 is preferably scored or plastically deformed when it is tightened to near its maximum strength on the spiral insert 100.

In operation, the conically shaped or tapered shaped bolt section 22 (enwrapped by the insert or spiral insert 100 along the entire surface of section 22 that will be inserted into the conical nut 200) is inserted into the conically shaped inner chamber 208 of the nut 200. The bolt 10 can be turned (either clock-wise or counter clock-wise, depending on the winding direction of the spiral insert 100) to enter the hole or inner chamber 208 of the nut 200. Preferably, the spiral insert or spiral insert 100 press fits tightly onto the tapered section 22 of the bolt 10 and does not spin relative to the bolt 10. The spiral insert 100 press fits onto the bolt 10 and spins relative to the nut 200. As the bolt 10 is inserted further and further into the nut 200, the compressive force exerted on the spiral insert 100 increases as the distance between the conical face on tapered section 22 of the bolt 10 and the conical face on inner surface 206 of the nut 200 reduces. Lubrication is recommended to assist the sliding of the spiral insert 100 over the face of the nut 200.

There is a limit to how many turns of the bolt 10 before these compressive forces become so great that the spiral insert 100 is destroyed. Maximum tensile strength of the nut bolt combination is achieved just prior to the compressive destruction of the spiral insert or spiral insert 100, when the deformation of the face of the conical nut 200 and bolt 10 is at its maximum. The tensile strength of the nut bolt combination of the present invention was compared to traditional threaded nut bolt combinations of the same diameter. The present invention withstood 25% more tensile force prior to breaking.

The cost to make bolts and nuts of embodiments of the present invention is less than that for threaded bolts and nuts. A cylindrical bolt (smaller compared to those now made prior to cutting the threads) can be pressed into a conically shaped die mold (to create the tapered section such as tapered section 22), a low-cost operation with high repeatability. The spiral insert, such as spiral insert 100, is sleeved onto the conical bolt, such as bolt 10, the gripping force of the stretched spiral insert 100 holding it onto the bolt. To make a conical nut, such as 200, a traditional nut (prior to cutting the threads) can be reamed, a low cost operation with high repeatability.

The head of the bolt, such as head 26, and the outer diameter faces of the nut, such as surfaces 14a-14f, can be of any known configuration. Another option is to ream a conical hole in a surface, such as a wall (made of wood, cement, brick, metal, etc.), and to screw a conical bolt or conical bolt with insert combination, such as the bolt 10 and spiral insert 100 combination as shown in FIG. 7, having the appropriate dimensions and having an insert made of an appropriate material (metal, plastic, etc.) into the hole or inner chamber such as inner chamber 208.

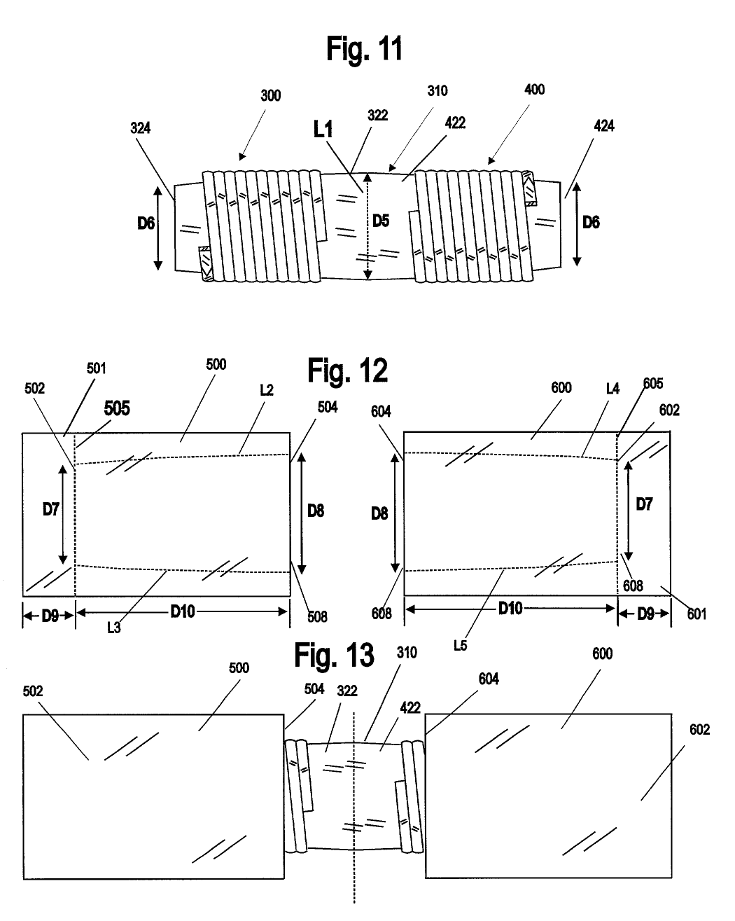

FIG. 11 shows a side view of a two sided bolt 310 with spiral insert 300 and spiral insert 400 attached in accordance with a second embodiment of the present invention. The two sided bolt 310 is comprised of tapered sections 322 and 422, each of which may be identical to the tapered section 22 in FIG. 1. The tapered sections 322 and 422 may actually be integrated together but are separated for descriptive purposes by dashed line L1. Tapered section 322 may have an initial diameter of D5 at L1 which tapers or decreases to a diameter of D6 at an end 324. Similarly, tapered section 422 may have an initial diameter of D5 at L1 which tapers or decreases to a diameter of D6 at an end 424. Each of the spiral inserts 300 and 400 may be identical to spiral insert 100 of FIG. 4.

FIG. 12 shows a side view of a bar or rod 500 and a bar or rod 600 having tapered inner chambers 508 and 608 respectively. The chambers 508 and 608 may be conically shaped and may have a depth of D10. The bar 500 and bar 600 may also include solid sections 501 and 601 which may have a length of D9. The length of the solid sections 501 and 601, i.e. D9, can be and most probably is longer than the depth, D10, of the chambers 508 and 509. Dashed lines L2 and L3 show the location of tapered inner chamber 508 within the bar 500. Dashed lines L4 and L5 show the location of tapered inner chamber 608 within the bar 600. Dashed lines 505 and 605 show the division between solid sections 501 and 601 and the section of the bars 500 and 600 having chambers 508 and 608 respectively. Each of the bars 500 and 600 may be similar to or identical to the nut 200 in FIG. 9 or simply may be an elongated version of the nut 200. The bar 500 has an inner conical cavity that tapers from a diameter D8 at end 504 which may be range from less than one-eighth of an inch to three inches or more to a diameter D7 at end 502 which may range from less than one-eighth of an inch to three inches or more. Similarly the bar 600 has an inner conical cavity that tapers from a diameter D8 at end 604 to a diameter D7 at end 602.

FIG. 13 shows the two bars 500 and 600 connected to the two sided bolt 310 of FIG. 11. Each of the bars 500 and 600 may be connected in a manner similar to that shown in FIG. 10, for nut 200 connected to bolt 10 and in a manner previously described for connecting nut 200 to spiral insert 100 and thus to bolt 10.

FIG. 14 shows a cross section of a bolt shaft 720, a nut 800 and a spiral insert 700 in accordance with another embodiment of the present invention where the spiral insert 700 has a octagonal cross section such as shown by portion 702. The spiral insert 700 may be similar to the spiral insert 100 of FIG. 4, except that the spiral inset 700 has an octagonal cross section. The bolt shaft 720 has a tapered section 721 which decreases from a diameter or dimension of D11 at dashed line L1 to a diameter or dimension D12 at end 722. The nut 800 includes sections 802 and 804.

FIG. 15 shows a cross section of a bolt shaft 720, the nut 800 and a spiral insert 750 in accordance with another embodiment of the present invention where the spiral insert 750 has a hexagonal cross section such as shown by portion 752. The spiral insert 750 may be similar to spiral inserts 100 and 700 except that the spiral insert 750 has a hexagonal cross section.

Conical holes or conical inner chambers 508 and 608 can be reamed into the ends of the bars or rods 500 and 600.

Another benefit of the present invention in various embodiments is that no lock washer is necessary to prevent the unwanted loosening of the nut on the bolt due to vibration or dynamic use. The compressive force of the spiral insert on the faces of the nut and bolt provides significant resistance to turning, preventing the nut from spinning off the bolt.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a bolt having a shaft which includes a first tapered section; and
a first spiral insert which can be placed over the first tapered section of the shaft and thereby fixed to the bolt.

2. The apparatus of claim 1 wherein the first spiral insert is a spring.

3. The apparatus of claim 1 wherein
the bolt includes a bolt head.

4. The apparatus of claim 1 wherein
the shaft includes a uniform section which has a uniform diameter.

5. The apparatus of claim 1 further comprising
a nut which has a tapered inner chamber such that the nut can be placed over the first spiral insert to fix the nut to the first spiral insert and to thereby fix the nut to the bolt.

6. The apparatus of claim 1 wherein
the first tapered section is conical in shape and has a first diameter which tapers to a second diameter which is smaller than the first diameter.

7. The apparatus of claim 6 wherein
the first spiral insert can be placed over an end of the first tapered section which has a diameter of the second diameter.

8. The apparatus of claim 7 wherein
the second diameter is slightly less than the first diameter.

9. The apparatus of claim 1 wherein
the shaft of the bolt further comprises a second tapered section;
and further comprising a second spiral insert which can be placed over the second tapered section of the shaft and thereby fixed to the bolt.

10. The apparatus of claim 9 wherein
the first spiral insert is a spring and the second spiral insert is a spring.

11. The apparatus of claim 9 and further comprising
a first bar which has a tapered inner chamber such that the first bar can be placed over the first spiral insert to fix the first bar to the first spiral insert and to thereby fix the first bar to the bolt; and
a second bar which has a tapered inner chamber such that the second bar can be placed over the second spiral insert to fix the second bar to the second spiral insert and to thereby fix the second bar to the bolt.

12. A method comprising the steps of
creating a first tapered section on a first end of a bolt; and
pressing a first spiral insert over the first end and over the first tapered section.

13. The method of claim 12 further comprising the steps of
creating a second tapered section on a second end of the bolt; and
pressing a second spiral insert over the second end and over the second tapered section.

14. The method of claim 13 wherein
the step of creating the first tapered section on the first end of the bolt includes pressing the bolt into a mold.

15. The method of claim 14 wherein
the step of creating the first tapered section on the first end of the bolt includes pressing the bolt into a mold which creates a conical shape.

16. The method of claim 12 further comprising the steps of
creating a tapered inner chamber in a nut.

17. The method of claim 16 wherein
the nut initially has a chamber with a substantially uniform diameter and then the nut is reamed to provide a tapered inner chamber.

18. The method of claim 17 wherein
the first spiral insert is a spring.

19. The apparatus of claim 8 wherein
the first diameter is between about one-eighth of an inch and about three inches.
